(19) United States
(12) Patent Application Publication
(10) Pub. No.: US 2010/0023942 A1
(43) Pub. Date: Jan. 28, 2010

(54) ACCELERATING VIRTUAL MACHINE RESUME TIME USING A PRE-CACHED WORKING SET

(76) Inventors: Philip SHEU, San Jose, CA (US); Kevin Lawton, San Francisco, CA (US); Victor Chin, San Jose, CA (US)

Correspondence Address: GLENN PATENT GROUP, 3475 EDISON WAY, SUITE L, MENLO PARK, CA, 94025, US

(21) Appl. No.: 12/508,430

(22) Filed: Jul. 23, 2009

Related U.S. Application Data
(60) Provisional application No. 61/083,124, filed on Jul. 23, 2008.

(51) Int. Cl. G06F 9/455

(52) U.S. Cl. 718/1

(57) ABSTRACT

A client transitions between a suspended virtual machine (VM) state and an active VM state by employing a working set comprising a VM state file and a working set index file. The VM state file serializes each of the VM components that is saved to storage. The working set index file contains indirect information that records the offset, length, and region of various pieces of the VM state and contains a VM working set. The VM suspend state serialization is implemented as either a monolithic or an incremental process.

### CROSS REFERENCE TO RELATED APPLICATIONS

This patent application claims the benefit of U.S. provisional patent application Ser. No. 61/083,124, Virtual Machine, filed Jul. 23, 2008, the entirety of which is incorporated herein by this reference thereto.

### BACKGROUND OF THE INVENTION

1. Technical Field

This invention relates generally to the field of virtual machines (VMs). More specifically, this invention relates to the reduction of the time it takes to resume a VM from a suspended state.

2. Description of the Related Art

A client can run multiple operating systems (OS) with corresponding applications at the same time by using virtualization software. VMs provide a container environment, which runs on top of the physical hardware and virtualizes the resources of the machine. An OS runs inside the VM, sometimes without any knowledge that it is running within the container rather than directly on the physical hardware. Virtualization typically comprises a hypervisor for coordinating between multiple OSes by allocating system resources. In addition, virtualization can include specialized hardware features to facilitate virtualization on the client.

Virtualization is used when a guest OS, e.g. Microsoft Windows is incompatible with the host OS, e.g. Linux that runs natively on the client hardware. The operating systems run simultaneously by running the guest OS inside a VM. In fact, more than one VM can be run using virtualization, with each VM running an arbitrary and unique software environment.

One of the benefits of virtualization is that a VM can be suspended and resumed without requiring the environment running in the VM to facilitate the suspend and resume activities. This allows a user, for example, to suspend an arbitrary software environment running in a VM at any point in time. Generally, the state of the VM is saved to a disk or other storage means. The saving of the state to storage is referred to as serialization. After suspension, the VM does not consume computer system resources other than the storage requirements to serialize state. Later, if there is a need to use the software environment in the VM, the virtualization software allows the VM to be resumed at the point it was suspended, without having to re-boot the VM OS. This offers an expedient way to use the VM and provides a convenient way to start using the VM in a state consistent with how it was last used.

Resuming a suspended VM involves the process of de-serialization, i.e. the VM state is read from a disk or other storage means, and loaded into an active VM context, with the intent to begin VM execution quickly thereafter. The de-serialization process can be monolithic as the VM state waits to be completely loaded before beginning VM execution. Monolithic de-serialization is easy to design; however, the user must wait longer than if the loading process is incremental.

When a VM state is loaded incrementally, a partial VM state is loaded and accessible to a user while the remainder of the VM state loads in the background. Partial loading can be performed on-demand, according to the VM execution requirements. Incremental de-serialization yields a much improved, although not immediate, time-to-use because less state is loaded into a VM context before the VM begins execution. Consequently, many modern virtualization programs for user-interactive VMs employ incremental de-serialization.

One downside to incremental de-serialization is that the VM uses execution to dynamically learn which state to draw in from storage, which imposes many delays and dependencies on the VM state that has not yet been fetched. The VM execution is often temporarily pending until each new piece of state is fetched. If a given VM is suspended and resumed a number of times in sequence, the resume time trends downward until it reaches a lower floor. The lower resume time occurs when many hosts attempt to buffer commonly and frequently use data in the memory.

When a VM state is loaded from a suspended state incrementally in a typical virtualization system, a partial VM state is loaded from memory and accessible to a user while the remainder of the VM state loads in the background. Each time a VM is suspended and subsequently resumed, the host learns with better resolution what the working set is for the related VM. By keeping more of the working set in memory, the incremental de-serialization becomes more expedient.

When the client is powered off and subsequently powered on, it loses all notion of working sets of all software workloads that were previously executing. Thus, the first time a VM is resumed after a host is powered on, it takes several suspend and resume actions to obtain a reasonable working set to be saved into memory before a VM can be executed.

### SUMMARY OF THE INVENTION

The time between activating a suspended VM and resuming the VM is reduced by creating a working set comprising a VM state file and a working set index file. The VM state file serializes each of the VM components that is saved to storage. The working set index file contains indirect information that records the offset, length, and region of various pieces of the VM state. The VM suspend state serialization is implemented as either a monolithic process or as an incremental process.

In one embodiment, the working set is pre-cached into memory before the VM is launched. When the VM is suspended and then resumes, the working set is fetched from the host memory or disk/storage. In another embodiment, the steps of fetching or pre-caching the working file are incorporated into the VM launch or VM resume steps.

### BRIEF DESCRIPTION OF THE DRAWINGS

FIG. 1 is a block diagram that illustrates a client according to one embodiment of the invention;

FIG. 2A is a block diagram that illustrates the components of an active VM according to one embodiment of the invention;

FIG. 2B is a block diagram that illustrates a VM state file and a VM working set index file for tracking the current working state of the VM according to one embodiment of the invention; and

FIG. 3 is a flow diagram that illustrates the steps of a VM resume according to one embodiment of the invention.

### DETAILED DESCRIPTION OF THE INVENTION

System Architecture

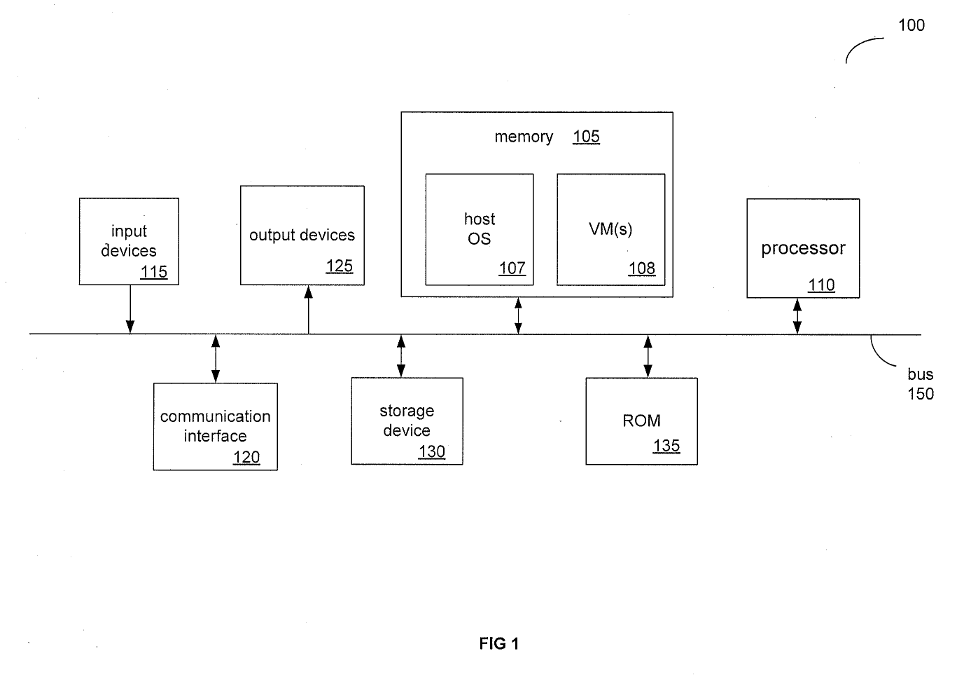

In one embodiment, the client 100 comprises a computing platform configured to act as a client device, e.g. a personal computer, a notebook, a smart phone, a digital media player, a personal digital assistant, etc. FIG. 1 is a block diagram of a client 100 according to one embodiment of the invention. The client 100 includes a bus 150, a processor 110, a main memory 105, a read only memory (ROM) 135, a storage device 130, one or more input devices 115, one or more output devices 125, and a communication interface 120. The bus 150 include one or more conductors that permit communication among the components of the client 100.

The processor 110 includes one or more types of conventional processors or microprocessors that interpret and execute instructions. Main memory 105 includes random access memory (RAM) or another type of dynamic storage device that stores information and instructions for execution by the processor 205. ROM 135 includes a conventional ROM device or another type of static storage device that stores static information and instructions for use by the processor 110. The storage device 130 includes a magnetic and/or optical recording medium and its corresponding drive.

Input devices 115 include one or more conventional mechanisms that permit a user to input information to a client 100, such as a keyboard, a mouse, etc. Output devices 125 include one or more conventional mechanisms that output information to a user, such as a display, a printer, a speaker, etc. The communication interface 120 includes any transceiver-like mechanism that enables the client 100 to communicate with other devices and/or systems. For example, the communication interface 120 includes mechanisms for communicating with another device or system via a network.

The software instructions that define the host OS 107 and any VMs 108 are read into memory 105 from another computer readable medium, such as a data storage device 130, or from another device via the communication interface 120. The processor 110 executes computer-executable instructions stored in the memory 105. The instructions comprise object code generated from any compiled computer-programming language, including, for example, C, C++, C# or Visual Basic, or source code in any interpreted language such as Java or JavaScript.

Writing a Working Set and Resuming a Suspended VM

In one embodiment, a working set for each VM is tracked and cached or pre-fetched into a host or VM memory, such that de-serialization is accelerated. This improves the resume operation for all instances, including first time use.

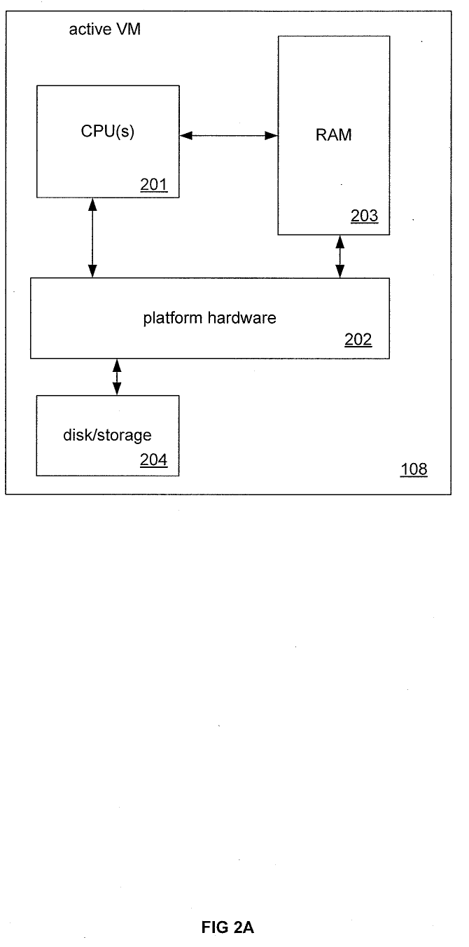

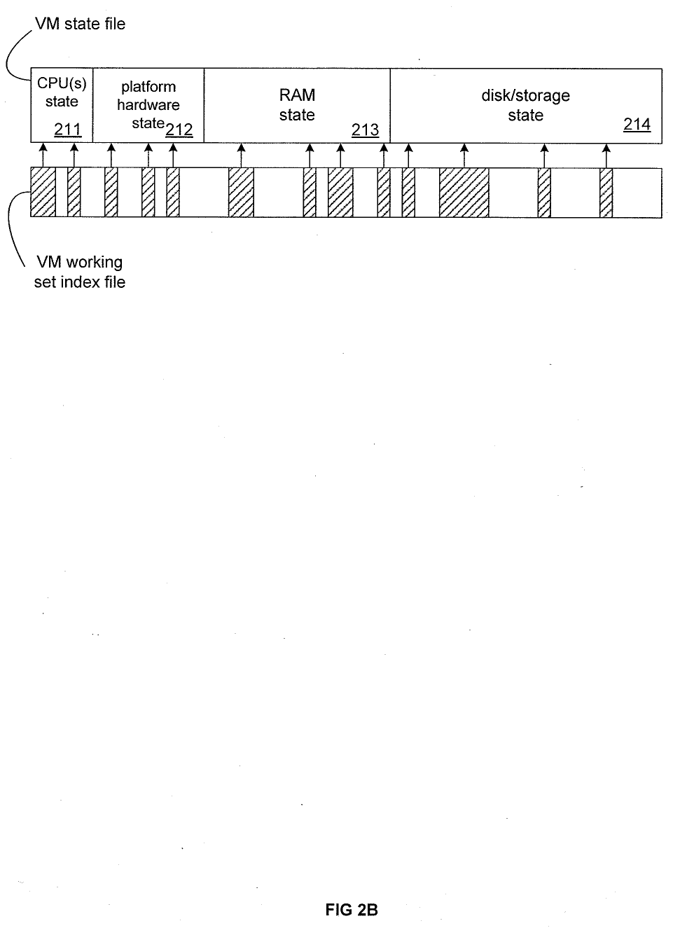

FIGS. 2A and 2B are block diagrams that illustrate a more detailed view of a VM state, how it is serialized to storage, and how a VM working set is tracked. The active VM 200 illustrates a simplified view of a virtualized system context that is exposed to a VM 108. The active VM 200 comprises at least one central processing unit (CPU(s) 201), platform hardware 202, RAM 203, and disk-storage 204.

In one embodiment of the invention, the RAM 203 and disk/storage 204 accessed by the active VM 200 is not the only memory available on the client 100. The memory that is accessed by virtualization software is frequently partitioned from the memory that is accessed by the host so that, for example, the different systems can run independently.

The active VM 200 represents the active state of a VM 108 and its components, while running an OS and applications. The active VM 200 runs on either a hardware platform or a software platform that provides an interface between the active VM 200 and the hardware.

When an active VM 200 is suspended, it is serialized to storage, for example, a file on the host disk system. FIG. 2B illustrates the serialized state. The VM state file 210 illustrates a serialized state where portions of the VM state file 210 correspond to each active VM 200 context component. Specifically, the VM state file 210 comprises the following portions: CPU(s) state 211, platform hardware state 212, RAM state 213, and disk/storage state 214. A person of ordinary skill in the art will recognize that FIG. 2B illustrates an example where the portions of the state file 210 can be arranged in a different order, further apportioned for additional components, etc.

The VM suspend state serialization is implemented as either a monolithic operation or an incremental process. In a monolithic operation, the VM is completely suspended from execution while writing the VM state to storage. In an incremental process, the active VM 200 continues to execute while the VM state is written to storage, until VM execution is suspended and the remaining modified state is written to storage.

In one embodiment of the invention, at the end of the VM suspend process, information regarding the current working set of the VM state is recorded and stored as a VM working set index file 215 in host memory or disk/storage 204. The VM working set comprises a highly used state, a most recently used state, a critical state, and a high priority state. In one embodiment of the invention, the hypervisor determines the working set state. In another embodiment, the host OS determines the working set state. In a further embodiment, an agent in a guest VM specifies the working state based on more intimate knowledge of the guest OS and software application. The agent provides the information to the hypervisor or a VM suspend agent. In yet another embodiment, these methods are combined to make a determination of what VM state comprises the current working state.

When a VM is suspended, working set information is made available to the associated VM working set index file 215. This information is incorporated into the VM state, as well as in separate storage. The VM working set index file 215 is shown as a separate storage entity, and is comprised of a set of indirection information to record the offset, length, and region of various pieces of a VM state that capture a VM's current working set. In the embodiment illustrated in FIG. 2B, no actual state data is stored in the VM working set index file 215.

Flow Chart

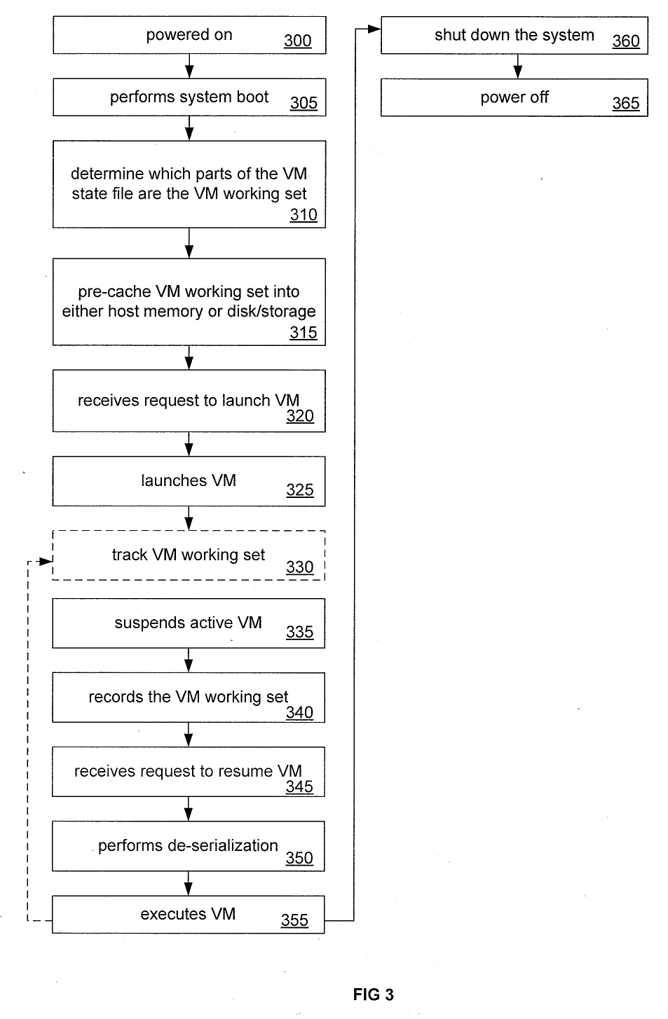

FIG. 3 is a flow chart that illustrates a computer system life cycle from power-on to power-off, including resume to suspend. The flow chart also illustrates that the VM resume is accelerated by remembering the VM working set information upon suspend, such that it can be used to enhance a subsequent VM resume.

Initially, a client 100 is powered on 300. The client 100 performs 305 the system boot. Generally, system hardware and initial software begin to initialize promptly. As the system continues to boot, the client launches higher level software and performs a sequence of operations in preparation of normal system operation. While this phase can take minutes on some systems, the Splashtop® instant-on system developed by DeviceVM® performs this phase in seconds.

The client 100 performs resume acceleration. Specifically, a VM's working set index file 215 is used to determine 310 which parts of the VM state file 210 are the VM working set. Those parts are pre-cached 315 into either host memory or VM disk/storage 204. With a working set in memory, the client 100 executes the VM quickly, thereby accelerating the effective resume time.

The working set is typically fetched by the time a VM launch is requested. As long as some of the working set is loaded by the time the VM launches, however, the time between VM resume and VM execution is reduced. This order is preferred in an environment that is instant-on and that aims to be operational in seconds from an initial power-on event. This order is also preferred when a user or administrator selects one VM for launch right after the client 100 is powered-on. In another embodiment, the resume acceleration step is activated during other phases or is incorporated into the VM launch or VM resume.

In yet another embodiment, multiple VMs run on the same client 100, each with its own working set. Different orders for pre-caching and fetching or simultaneous launch of the VM and loading of the working set can be applied to each VM.

The client 100 receives 320 a request from another program or a user to launch the VM 200. Alternatively, the VM 200 is automatically launched as a result of the power-on sequence. The client 100 launches 325 the VM 200. In one embodiment of the invention, the client 100 tracks 330 the VM working set while the VM is active. In some embodiments, the client records the VM working set before suspension. The steps of tracking and recording can be monolithic or incremental processes.

At some point, the client 100 suspends 335 the active VM 200, in response to activating a host OS, another VM, etc. Suspension is either a monolithic or an incremental process. The client 100 records 340 the VM working set.

During system operation, a user or a program may request that the client 100 resume a previously suspended VM 108. The client 100 receives 345 the request to resume the VM. The client 100 performs 350 de-serialization of the VM state using the VM working set by fetching enough initial state information to invoke VM execution. The client 100 executes 355 the VM 108. The steps of tracking, suspending, and recording can be repeated indefinitely according to the needs of the client 100.

The VM continues operations in an active state or a suspend state until the client 100 receives a request or internal instruction to shut down. The client 100 shuts down 360 the system. The client 100 powers off 365.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims.

1. An apparatus for reducing a time between suspension of a virtual machine (VM) and resumption of the VM comprising:
a memory comprising a main memory and a cache;
a processor, the processor configured to implement instructions stored in the memory;
a host operating system (OS);
the VM, the VM having a plurality of states;
a VM state file stored in the cache comprising a serialized state of the VM, wherein each portion of the state file corresponds to an active VM context component;
a VM working set index file stored in the cache comprising a set of indirection information that describes a region of each piece of a VM state that captures the VM working set, the VM working set index file being used to determine which parts of the VM state file are the VM working set;
means for initiating a suspension of the VM; and
means for storing the VM working set in the cache before the VM is suspended.

2. The apparatus of claim 1, wherein the context components comprise any of a central processing unit (CPU) state, a platform hardware state, a random access memory (RAM) state, a disk state, and a storage state.

3. The apparatus of claim 1, wherein suspend state serialization is implemented as a monolithic process by completely loading the VM state before VM execution.

4. The apparatus of claim 1, wherein suspend state serialization is implemented as an incremental process by loading part of the VM state and making it accessible while the rest of the VM state loads in the background.

5. The apparatus of claim 1, wherein the state of the VM working set comprises any of a highly used state, a most recently used state, a critical state, and a high priority state.

6. The apparatus of claim 1, wherein the state of the VM working set is determined by any of the host OS and an agent in a guest VM.

7. The apparatus of claim 1, wherein any additional VMs are associated with a different working set.

8. A computer-implemented method for reducing a time between suspension of a virtual machine (VM) and resumption of the VM, the method comprising:
powering on a computer;
performing, with the computer, a system boot;
determining, with the computer, which parts of a VM state file are a VM working set;
fetching, with the computer, the VM working set;
launching, with the computer, the VM;
tracking, with the computer, the VM working set; and
suspending, with the computer, the VM

9. The method of claim 8, further comprising the step of:
recording, with the computer, the VM working set.

10. The method of claim 9, wherein the step of recording the VM working set is a monolithic de-serialization process that completely records the VM state before VM suspension.

11. The method of claim 9, wherein the step of recording the VM working set is an incremental de-serialization process that records part of the VM state and makes it accessible while the rest of the VM state suspends in the background.

12. The method of claim 9, further comprising the steps of:
receiving, with the computer, a request to launch the VM;
performing, with the computer, de-serialization; and
executing, with the computer, the VM.

13. The method of claim 12, wherein the step of performing de-serialization is a monolithic de-serialization process that completely loads the VM state before VM execution.

14. The method of claim 12, wherein the step of performing de-serialization is an incremental de-serialization process that loads part of the VM state and makes it accessible while the rest of the VM state loads in the background.

15. A computer program product for reducing a time between suspension of a virtual machine (VM) and resumption of the VM comprising a computer-readable storage medium storing program code for executing the following steps:
performing a system boot;
determining which parts of a VM state file are a VM working set;
fetching the VM working set;
launching the VM;
tracking the VM working set; and
suspending, with the computer, the VM.

16. The computer program product of claim 15, further comprising the step of:
recording the VM working set.

17. The computer program product of claim 15, wherein the step of recording the VM working set is a monolithic de-serialization process that completely records the VM state before VM suspension.

18. The computer program product of claim 15, wherein the step of recording the VM working set is an incremental de-serialization process that records part of the VM state and makes it accessible while the rest of the VM state suspends in the background.

19. The computer program product of claim 16, further comprising the steps of:
receiving a request to launch the VM;
performing de-serialization; and
executing the VM.

20. The computer program product of claim 19, wherein the step of performing de-serialization is a monolithic de-serialization process that completely loads the VM state before VM execution.
